(19) United States
(12) Patent Application Publication
(10) Pub. No.: US 2002/0140550 A1
(43) Pub. Date: Oct. 3, 2002

(54) Anti-theft device for a motor vehicle

(76) Inventor: Gregory E. Frattaroli, Toronto (CA)

Correspondence Address: Gregory E. Frattaroli, 26 Marilyn Ave., Toronto, ON, M1S1C1, CA

(21) Appl. No.: 10/096,434

(22) Filed: Mar. 13, 2002

(30) Foreign Application Priority Data
Mar. 21, 2001 (CA) 2,339,305

(51) Int. Cl. B60R 25/10

(52) U.S. Cl. 340/426; 340/425.5; 340/815.45

(57) ABSTRACT

This invention relates to an electronic anti-theft device for a motor vehicle. The device simulates the operation of a security alarm system.

To give the appearance that a motor vehicle is equipped with a security alarm system, it is common to use a light-emitting diode, or a similar light-emitting mechanism, (“LED”), installed, possibly with the aid of an LED holder, at the vehicle's steering wheel column, dashboard, floor console or another highly visible location. The LED is powered by the vehicle's battery and, while activated, flashes on and off to deter thieves. The LED remains activated or a switch is incorporated for manual activation and deactivation. Alternatively, by splicing into the vehicle's ignition wires, the LED is automatically, activated while the vehicle's ignition system is off and, deactivated while the ignition system is on.

The present invention comprises an improved means of installing the LED such that it is automatically, activated while the motor vehicle's ignition system is off and, deactivated while the ignition system is on, without having to splice into the vehicle's ignition wires. Furthermore, the invention incorporates either a fuse or a circuit breaker to guard against a circuit overload and means by which to adjust the characteristics of the LED's flash. Finally, the invention is compatible with the actual LED, and any related assembly thereto, that forms part of the security alarm system supplied by the vehicle's manufacturer.

This invention relates to an electronic anti-theft device for a motor vehicle. The device is designed to deter vehicular thefts and break-ins by simulating the operation of, and thereby giving the appearance that the vehicle is equipped with, a security alarm system.

A security alarm system for a motor vehicle typically incorporates a light-emitting diode, or a similar light-emitting mechanism, (“LED”), situated at the vehicle's steering wheel column, dashboard, floor console or another highly visible location. Typically a hand-held remote control device is used to arm the system (thereby activating the LED) when the vehicle is not in use and to disarm the system (thereby deactivating the LED) when the vehicle is in use. While activated, the LED flashes on and off to warn thieves that the vehicle is protected.

To give the appearance that a motor vehicle is equipped with a security alarm system, it is common to use an LED installed, possibly with the aid of an LED holder, at the vehicle's steering wheel column, dashboard, floor console or another highly visible location. The LED is powered by the vehicle's battery and has either built-in or external circuitry that causes it, while activated, to flash on and off The LED remains activated or a switch (installed at an inconspicuous location within the vehicle) is incorporated for manual activation and deactivation. Alternatively, the vehicle's ignition system is incorporated by means of a relay or by splicing into the vehicle's ignition wires, to automatically, activate the LED while the ignition system is off and, deactivate it while the ignition system is on.

This is unsatisfactory, however, for the following reasons. First, a flashing LED that remains activated poses a dangerous and an annoying distraction while driving, particularly after dark If a switch is incorporated to overcome this problem, then one must remember, and is significantly inconvenienced by having, to manually operate it upon entering and exiting the motor vehicle. Second, a flashing LED which remains activated while the vehicle is in use, or which requires manual activation and deactivation, is a telltale sign to passengers or bystanders that the vehicle's security alarm system is a fake. Third, if the vehicle's ignition system is incorporated to overcome these problems, the use of a relay or the splicing of the ignition wires is not only unnecessary, costly, inefficient, potentially damaging and time consuming but also may invalidate the vehicle's manufacturer's warranty. Fourth, if the LED's circuit becomes overloaded (e.g., due to a short), the LED's circuitry will overheat and represent a potential hazard. Fifth, there are no means by which to adjust the intensity (i.e., the brightness), frequency (i.e., the rate), and duration (i.e., the length of time), of the LED's flash. Such adjustments ensure that the LED's flash is highly visible (regardless of the LED's location within the vehicle) and authentic looking (so as not to be suspected as being fake).

The present invention overcomes the aforementioned difficulties and inconveniences as follows. First, the invention comprises an improved means of installing the LED, which takes advantage of the motor vehicle's existing spare battery terminal and spare ignition terminal (thereby making direct use of the motor vehicle's ignition system and avoiding the need for a relay or having to splice into the vehicle's ignition wires) to automatically, activate the LED while the vehicle's ignition system is off and, deactivate it while the ignition system is on. Consequently, the LED poses no distraction while driving, does not require manual activation and deactivation, and appears authentic, without invalidating the vehicle's manufacturer's warranty. Second, the invention incorporates a built-in either fuse or circuit breaker to guard against a circuit overload. Third, the invention incorporates means by which to adjust the intensity, frequency, and duration, of the LED's flash. Finally, an additional optional benefit of the invention is that it is compatible with the actual LED, and any related assembly thereto (such as lead wires, a lens which refracts the LED's flash, a casing which is used to house and mount the LED and related assembly inside the vehicle, and an “anti-theft” or similar warning label), that forms part of the security alarm system supplied by the vehicle's manufacturer. This option gives the appearance that the vehicle is equipped with the original manufacturer's security alarm system as opposed to an after-market system.

The accompanying drawings entitled

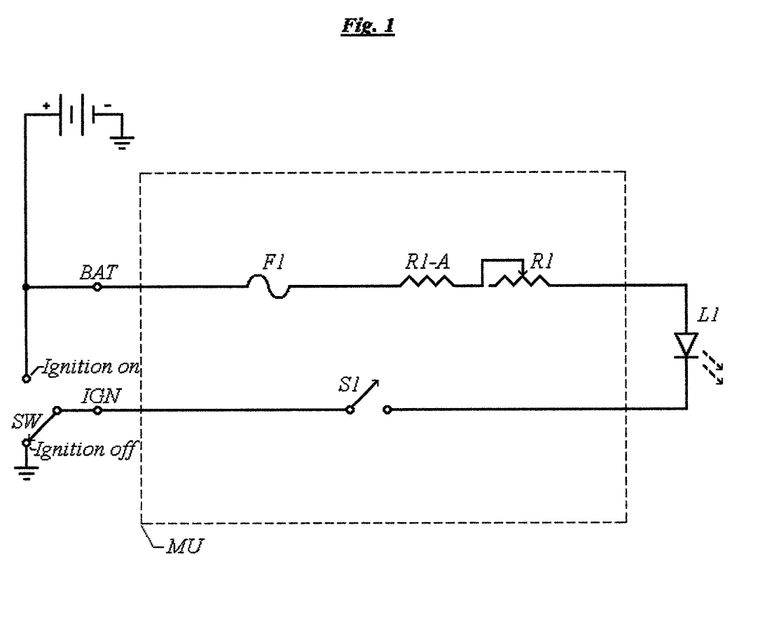

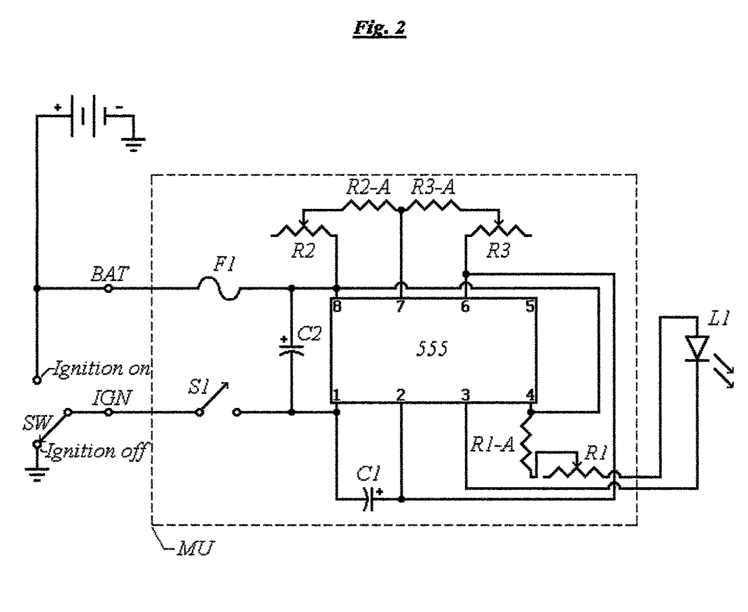

FIG. 1 (“FIG. 1”) and FIG. 2 (“FIG. 2”) are schematic diagrams of preferred versions of the invention.

The FIG. 2 version is an advanced form of the FIG. 1 version.

FIG. 1 and FIG. 2 contain certain reference characters that are described as follows:

Existing Components of the Motor Vehicle (as Depicted in FIG. 1 and FIG. 2)

BAT A spare battery terminal (accessed within the motor vehicle's interior fuse panel which, in turn, is typically located beneath or within the dashboard). A vehicle has one or more spare battery terminals. The spare battery terminal is an extension of the positive terminal of the vehicle's battery and, consequently, is a source of positive direct current. With the exception of older vehicles, typically the spare battery terminal is linked to its own fuse. This fuse is not depicted in FIG. 1 and FIG. 2 as it is bypassed upon installation of the anti-theft device (which already has a built-in either fuse or circuit breaker, as described hereafter).

IGN A spare ignition terminal (also accessed within the motor vehicle's interior fuse panel). A vehicle has one or more spare ignition terminals. While the vehicle's ignition system is on, the spare ignition terminal operates like the spare battery terminal. However, while the ignition system is off the spare ignition terminal is grounded. With the exception of older vehicles, typically the spare ignition terminal is linked to its own fuse. This fuse is not depicted in FIG. 1 and FIG. 2 as it is also bypassed upon installation of the anti-theft device.

SW The key-operated ignition switch (used to turn the motor vehicle's ignition system on and off.

Components of the Anti-Theft Device (as Depicted in FIG. 1)

L1 An LED. The LED has a built-in integrated circuit that causes the LED, while activated, to flash on and off. The flashing LED deters thieves by giving the appearance that the motor vehicle is equipped with a security alarm system. The LED may have a built-in resistor that protects the LED's circuitry from excessive current. The LED may be accompanied by an LED holder, which is used as an aid in mounting the LED inside the vehicle.

F1 A fuse or, alternatively, a circuit breaker. The fuse, or the circuit breaker, is a safety feature that blows, or trips, thereby interrupting the anti-theft device's circuit, if the current exceeds the fuse's, or the circuit breaker's, amperage rating. Since the anti-theft device requires only a nominal amount of direct current to operate, the fuse, or the circuit breaker, has a very low amperage rating to adequately protect the device's circuit from overloading.

R1 A (optional) variable resistor. The resistor provides a means by which to adjust primarily the intensity of the LED's (L1's) flash. As the resistance increases, the intensity decreases.

R1-A A (optional) fixed resistor. The resistor controls the maximum level of intensity of the LED's (L1's) flash. This maximum level can be lowered by increasing the resistance of the resistor. If necessary, the resistor also protects the LED's circuitry from excessive current.

S1 A switch. The switch is used to manually enable and disable the anti-theft device's operation. This feature is particularly useful if the motor vehicle is not in use for an extended period of time (e.g., if the vehicle is in storage during the winter months). In such a circumstance, the anti-theft device's operation may not be required and can be disabled to avoid an unnecessary (albeit nominal) power drain on the vehicle's battery.

MU The main unit. The main unit comprises a compact case that houses the fuse, or alternatively the circuit breaker, (F1), the resistors (R1 and R1-A), and the switch (S1).

The main unit is designed to permit easy access to replace the fuse (if it has blown) or to reset the circuit breaker (if it has tripped), to adjust the resistance of the resistor, R1, and to operate the switch.

Components of the Anti-Theft Device (as Depicted in FIG. 2)

L1 An LED as previously described except that it is controlled by an external integrated circuit (described hereafter), as opposed to a built-in one, that causes it, while activated, to flash on and off The LED may have a built-in resistor that protects the LED's circuitry from excessive current. The LED may be accompanied by an LED holder, which is used as an aid in mounting the LED inside the motor vehicle. As an option, the LED may be the actual LED, and any related assembly thereto (such as lead wires, a lens which refracts the LED's flash, a casing which is used to house and mount the LED and related assembly inside the vehicle, and an “anti-theft” or similar warning label), that forms part of the security alarm system supplied by the vehicle's manufacturer.

F1 A fuse, or alternatively a circuit breaker, as previously described.

555 A 555 timer integrated circuit. The 555 timer, in conjunction with C1, C2, R1, R1-A, R2, R2-A, R3 and R3-A (each described hereafter), causes the LED (L1), while activated, to flash on and off and provides means by which to adjust the intensity, frequency, and duration, of such flash.

C1 A (preferably) fixed or variable capacitor. The capacitor provides a means by which to adjust the frequency of the LED's (L1's) flash. As the capacitance increases, the frequency decreases.

C2 A fixed capacitor. The capacitor is connected across the power leads of the 555 timer (555). The capacitor ensures that a steady source of direct current is available to the 555 timer, which might otherwise malfunction.

R1 A (optional) variable resistor. The resistor provides a means by which to adjust the intensity of the LED's (L1's) flash. As the resistance increases, the intensity decreases.

R1-A A (optional) fixed resistor. The resistor controls the maximum level of intensity of the LED's (L1's) flash. This maximum level can be lowered by increasing the resistance of the resistor. If necessary, the resistor also protects the LED's circuitry from excessive current.

R2 A (optional) variable resistor. The resistor provides a means by which to adjust the frequency of the LED's (L1's) flash. As the resistance increases, the frequency decreases.

R2-A A fixed resistor. The resistor controls the maximum level of frequency of the LED's (L1's) flash. This maximum level can be lowered by increasing the resistance of the resistor. The resistor also protects the 555 timer's (555's) circuitry from excessive current.

R3 A (optional) variable resistor. The resistor provides a means by which to adjust the duration (and to a lesser extent the frequency) of the LED's (L1's) flash. As the resistance increases, the duration increases. Since this resistor affects both the duration and the frequency, it should be adjusted first, to obtain the desired duration, before adjusting the resistor (R2) and the capacitor (C1) (if it is a variable capacitor) to obtain the desired frequency

R3-A A fixed resistor. The resistor controls the minimum level of duration of the LED's (L1's) flash. This minimum level can be raised by increasing the resistance of the resistor. The resistor also protects the 555 timer's (555's) circuitry from excessive current.

S1 A switch as previously described.

MU The main unit. The main unit comprises a compact case which houses the fuse, or alternatively the circuit breaker, (F1), the 555 timer (555), the capacitors (C1 and C2), the resistors (R1, R1-A, R2, R2-A, R3 and R3-A), and the switch (S1). The main unit is designed to permit easy access to replace the fuse (if it has blown) or to reset the circuit breaker (if it has tripped), to adjust the capacitance of the capacitor, C1, (if it is a variable capacitor), to adjust the resistances of the resistors, R1, R2 and R3, and to operate the switch.

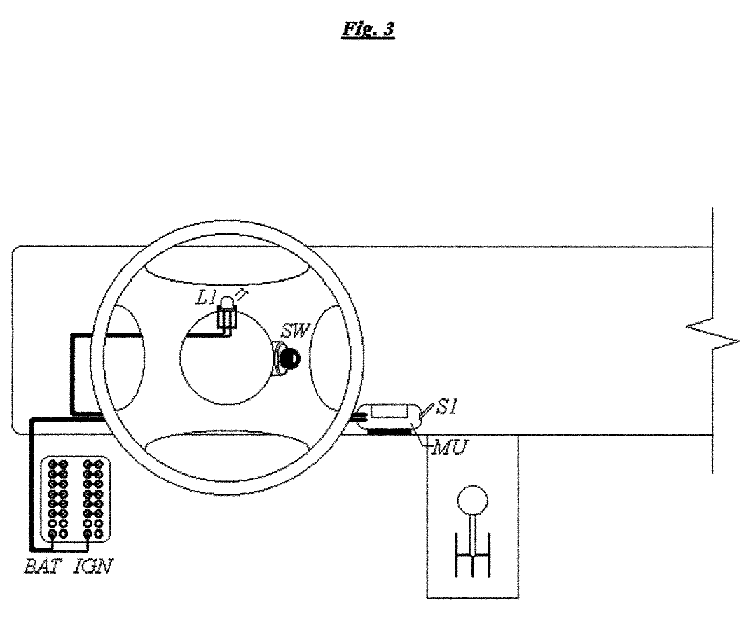

The FIG. 1 and FIG. 2 versions of the invention are installed in the motor vehicle as follows (refer to the accompanying drawing entitled FIG. 3 (“FIG. 3”), which contains the same reference characters as previously described for an illustration of a typical installation). The LED (L1) is installed, possibly with the aid of an LED holder, at the vehicle's steering wheel column, dashboard floor console or another highly visible location. The LED's positive and negative lead wires are fed in behind the dashboard and connected (mindful of correct polarity) to the main unit (MU). The main unit is installed, by means of Velcro [trade-mark] or similar means, at an inconspicuous and accessible location (typically beneath or within the dashboard) near the vehicle's interior fuse panel. The main unit's positive and negative lead wires are connected directly (thereby bypassing the linked fuses, if any) to the spare battery terminal (BAT) and the spare ignition terminal (IGN) respectively.

The FIG. 1 and FIG. 2 versions of the invention operate as follows. While the switch (S1) is in a closed position, the anti-theft device's operation is enabled. The key-operated ignition switch (SW) is used to turn the motor vehicle's ignition system on and off. While the vehicle's ignition system is off, the positive direct current from the spare battery terminal (BAT) and the grounding of the spare ignition terminal (IGN) completes a circuit such that the LED (L1) is activated and thereby flashes on and off. This gives the appearance that the vehicle is equipped with a security alarm system. Regarding the FIG. 1 version, the resistor, R1, provides a means by which to adjust primarily the intensity of the LED's flash. Regarding the FIG. 2 version, the capacitor, C1, (if it is a variable capacitor) and the resistors, R1, R2 and R3, provide means by which to adjust the intensity, frequency, and duration, of the LED's flash. While the vehicle's ignition system is on, the spare ignition terminal is no longer grounded and, consequently, the LED is deactivated. While the switch (S1) is in an open position, or if the fuse or alternatively the circuit breaker, (F1), is blown or tripped, the anti-theft device's operation is disabled.

Although the invention has been described with a certain degree of particularity, this has been done for the purpose of illustration only. The invention is not limited to this description but rather comprises all variations within the scope of the claims. Accordingly, variations in the invention's composition, installation and operation may be resorted to with the understanding that there has been no departure from the spirit or scope of the claims.

The embodiments of the invention in which an exclusive property or privilege is claimed are defined as follows:

1. An electronic anti-theft device, for a motor vehicle, comprising a light-emitting diode, or a similar light-emitting mechanism, (“LED”), that, while activated, flashes on and off which simulates the operation of, and thereby gives the appearance that the vehicle is equipped with, a security alarm system, wherein the improvement comprises the incorporation of the following components:
the vehicle's spare battery terminal and spare ignition terminal;
a fuse or, alternatively, a circuit breaker; and
adjustment means (“Adjustment Means”).

2. The device as claimed in claim 1 wherein the vehicle's spare battery terminal and spare ignition terminal are coupled to the LED and the means for flashing the LED such that power from the vehicle's battery to the LED is uninterrupted while the vehicle's ignition system is off, thereby automatically activating the LED, and is interrupted while the vehicle's ignition system is on, thereby automatically deactivating the LED, without the need for a relay or for splicing into the vehicle's ignition wires.

3. The device as claimed in claim 1 wherein the fuse will blow, or the circuit breaker will trip, thereby disabling the device's operation, if the current of the device's circuit exceeds the fuse's, or the circuit breaker's, amperage rating.

4. The device as claimed in claim 1 wherein the fuse or the circuit breaker and the Adjustment Means are contained in, yet remain accessible from, a compact case which is installed, by means of Velcro [trade-mark] or similar means, at an inconspicuous and accessible location inside the vehicle.

5. The device as claimed in claim 1 wherein the Adjustment Means, comprising one or more variable resistors and variable capacitors, is coupled to the LED and the means for flashing the LED such that each resistor's resistance and capacitor's capacitance can be varied to adjust any of the following characteristics, namely the intensity, frequency, and duration, of the LED's flash.
